(19) United States
(12) Patent Application Publication
(10) Pub. No.: US 2024/0362201 A1
(43) Pub. Date: Oct. 31, 2024

(54) EFFICIENTLY UTILIZING STORAGE CAPACITY BY A DATA PROTECTION APPLICATION WITHIN OBJECT STORAGE SYSTEMS

(71) Applicant: International Business Machines Corporation, Armonk, NY (US)

(72) Inventors: James Edward Damgar, Pima, AZ (US); Rennad Leigh David Murugan, Sugar Land, TX (US); Sameer Rajaram Veer, Austin, TX (US); Adam Gray, Chicago, IL (US); Asimuddin Kazi, Naperville, IL (US)

(21) Appl. No.: 18/139,432

(22) Filed: Apr. 26, 2023

(51) Int. Cl. G06F 16/23

(52) U.S. Cl. CPC G06F 16/2358

(57) ABSTRACT

A stored multi-part object management method, system, and computer program product for managing a stored multi-part object in a data storage application that includes modifying a stored multi-part object based on executing a predetermined operation and reporting a change to the multi-part object as a result of the modifying based on receiving a status request for the multi-part object.

### BACKGROUND

The present invention relates generally to a stored multi-part object management method, and more particularly, but not by way of limitation, to a system, method, and computer program product for managing a stored multi-part object in a data storage application.

Enterprise-level data protection applications often utilize data reduction technologies such as de-duplication and compression to optimize back-end storage efficiency when protecting user data. De-duplication “fingerprinting” algorithms in this space often produce de-duplicated “extents” in the range of 50 KB (kilobytes) to several MB (megabytes) in size from an incoming data stream (which may then be compressed/encrypted depending on user preferences).

Conventionally, for optimal “ingest” performance, these de-duplicated units of data are usually stored in larger logical groupings (i.e., Spectrum Protect “containers”), either as files on disk-where these larger I/O sizes provide greater file system efficiency-or as objects in object storage-where the larger aggregation can provide for a more optimal upload to object storage, asynchronous from the initial client backup or archive.

However, this aggregated structure of the conventional techniques can lead to difficult management in the case of immutable object storage. As client data ages and “expires”, individual de-duplicated extents may no longer be required. But, unlike with disk-based file storage, the regions of space they take up in the aggregated “containers” cannot be reused. Further, the data ranges in these objects cannot even be erased. Consequently, in the conventional techniques, excess storage usage in object storage above and beyond requirements can lead to additional cost for the user that is sub-optimal.

Moreover, from a data protection application perspective, conventional techniques of reducing consumed capacity within object storage for no-longer-needed data ranges in aggregate “container” objects is to perform some form of object storage “reclamation”.

For example, one conventional technique can be defined to tolerate certain threshold percentages of “empty” space within container objects and periodically “reclaim” objects which exceed this threshold. The application will read back (with HTTP “GET” operations) the still-needed data ranges from these objects and write this data out into new container objects (with HTTP “PUT” operations) with the old objects deleted (with HTTP “DELETE” operations).

But, this conventional technique has deficiencies in that it involves data egress and ingress out of and into the object storage device in terms of HTTP operations and data bandwidth. In the case of public object storage devices, these both may be metered and incur additional cost to the user. Even in the case of on-premises object storage devices, this egress and ingress will consume bandwidth within a user's Ethernet network and additional CPU and potentially storage bandwidth for both the data protection application system as well as the object storage device.

From an object storage device perspective, generally objects are considered “immutable” by the device and their content cannot be altered after being committed. Further, they cannot be resized or re-factored in a way that removes existing data ranges. There is not awareness provided to the object storage device of data composition within objects—such as what specific ranges of data in the aggregate object signify or “mean” to the application. The closest conventional approach to awareness is the common ability of a user of object storage to be able to store large objects using “multi-part upload” where the user can dictate the part size and quantity of “parts” for the object. However, no means of erasing existing parts is generally provided.

### SUMMARY

In view of the above-mentioned problems in the art, the inventors have considered a technical solution that provides a multi-part solution for the identified problem which combines new functionality on the object-storage-application-side for erasure of no-longer-needed data ranges within existing objects with new functionality on the data-protection-application-side for providing awareness and reaction to this object storage functionality for better data management.

Thereby, the invention provides a technical solution that involves an enhancement to an object storage device's handling of multi-part objects by providing a new inventive Application Programming Interface (API) for deeper management of these multi-part objects.

In an exemplary embodiment, the present invention can provide a computer-implemented method for managing a stored multi-part object in a data storage application, the computer-implemented method including modifying a stored multi-part object based on executing a predetermined operation and reporting a change to the multi-part object as a result of the modifying based on receiving a status request for the multi-part object.

In another exemplary embodiment, the present invention can provide a stored multi-part object management computer program product for managing a stored multi-part object in a data storage application, the stored multi-part object management computer program product including a computer-readable storage medium having program instructions embodied therewith, the program instructions executable by a computer to cause the computer to perform modifying a stored multi-part object based on executing a predetermined operation and reporting a change to the multi-part object as a result of the modifying based on receiving a status request for the multi-part object.

In another exemplary embodiment, the present invention can provide a stored multi-part object management system for managing a stored multi-part object in a data storage application, the stored multi-part object management system including a processor and a memory, the memory storing instructions to cause the processor to perform modifying a stored multi-part object based on executing a predetermined operation and reporting a change to the multi-part object as a result of the modifying based on receiving a status request for the multi-part object.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 depicts a computing environment 100 according to an embodiment of the present invention;

FIG. 2 exemplarily shows a high-level flow chart for a stored multi-part object management method 200 according to an embodiment of the present invention;

FIG. 3 exemplarily depicts operations 201a-201d that are executed during the modifying step 201 according to an embodiment of the present invention;

FIG. 4 exemplarily depicts effects of a data expiration and/or deletion operation involving a single front-end client application file according to an embodiment of the present invention; and

FIG. 5 exemplarily depicts a data state after the data expiration and/or deletion operation according to an embodiment of the present invention.

### DETAILED DESCRIPTION

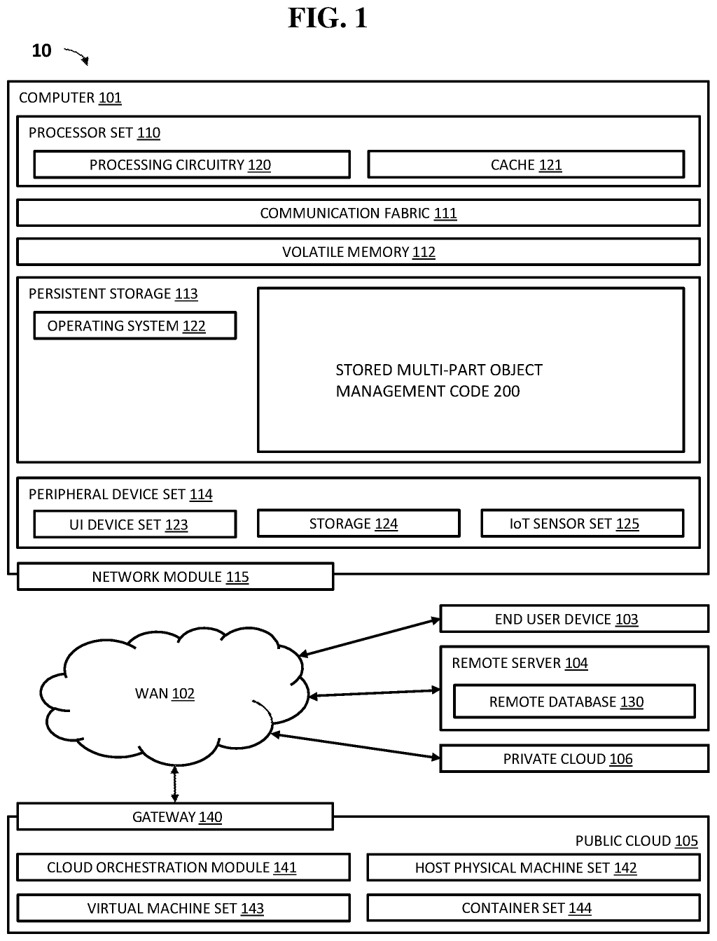

The invention will now be described with reference to FIGS. 1-5, in which like reference numerals refer to like parts throughout. It is emphasized that, according to common practice, the various features of the drawing are not necessarily to scale. On the contrary, the dimensions of the various features can be arbitrarily expanded or reduced for clarity.

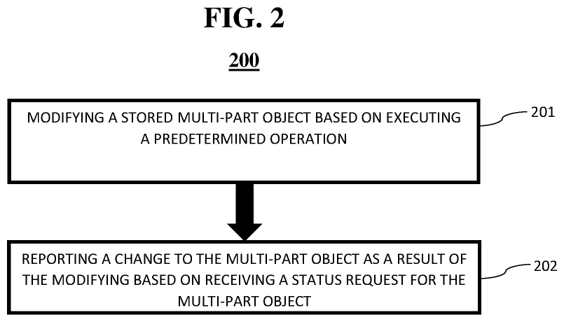

With reference now to the exemplary method 200 depicted in FIG. 2, the invention can include various steps for a system including an object storage feature that can eliminate (freeing up space) “parts” of multi-part objects by adding awareness to how ranges of de-duplicated extents map to one or more of these “parts”. This awareness can allow the data protection application to “free” and/or “reuse” this space (“parts”) within multi-part object storage objects and reduce storage consumption and cost (with metered, capacity-based usage billed plans).

The stored multi-part object management method 200 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

With reference generally to FIGS. 1-5, embodiments of the invention provide additional, needed (“convenience”) functionality for object storage consumers so that granular, logical management of multi-part objects can be a part of their workflow. Further, the invention can also allow for avoiding additional processing, bandwidth, and temporal costs of user applications having to perform re-factoring or erasure of object data ranges themselves.

That is, embodiments of the invention can involve an enhancement to a data protection application's management workflow for aggregated “container” objects in object storage. The data protection application may be enhanced to be made aware and keep track of “parts” within a multi-part uploaded object as logical ranges within these container objects and to track these within its catalog database. This tracking may be in addition to existing tracking of individual, variable-sized (i.e., ˜50 KB or above) de-duplicated extents within these aggregate container objects. This tracking may be augmented with additional knowledge of which part an extent is present within. Also, part tracking may keep track of how many “valid” (non-expired) extents exist within that part.

For example, as client data ages and “expires” within the data protection application, certain de-duplicated extents are no longer needed. The inventive application can determine if certain parts within container objects may be eliminated. An additional phase of the expiration process may eliminate these “empty” parts via an API call to a supporting object storage device to erase one or more parts from a multi-part (container) object. The data protection application will then query the object storage device for an updated eTag for its records. The data protection application may also initially compute its own checksum hashes of each part unit so that it can perform additional validation of data integrity when obtaining the results of this query.

In addition to erasure, to reduce the number of container objects outstanding, the data protection application may be enhanced to allow for insertion and replacement of new “parts” into the container object as new ingest (backup/archive) data is processed. The data protection application can make a choice of whether to aggregate and upload new container objects, or to direct data buffers to replace/insert into existing container objects based on its own heuristics and discretion.

The smaller the granularity of the “part size” (i.e., 5 MB minimum for the S3 protocol), the more efficient empty space “reclamation” may be.

With specific reference to FIG. 2, in step 201, a stored multi-part object may be modified based on executing a predetermined operation.

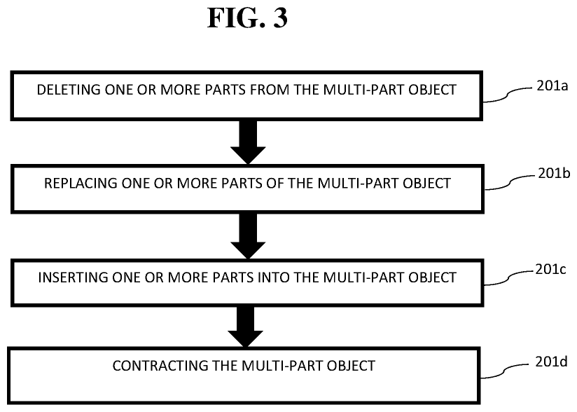

With reference to FIG. 3, the predetermined operation can include a plurality of operations 201a-201d where at least one of the plurality of operations is executed. The plurality of operations can include, for example, deleting (201a) one or more parts from the multi-part object, replacing (201b) one or more parts of the multi-part object, inserting (201c) one or more parts into the multi-part object, and contracting (201d) the multi-part object.

It is noted that a combination of the plurality of operations 201a-201d can be executed during the modifying step of the stored multi-part object. For example, as a part of new backup (“ingest”), for a set of de-duplicated extents that need to be placed in a container (object), it may be the case that some would be placed into existing container objects (i.e., “replaced” within one of the empty ranges, provided that the set of chunks fits) and some remaining set could be placed into new containers (objects). The only “deletion” from the object storage point of view should be deletion (removal) of parts in multi-part objects. This would occur as an additional (new) phase of “expiration” by the data protection application.

The inserting of the one or more parts into the multi-part object can include at least one of re-ordering or re-labeling of one or more parts of the multi-part object.

The contracting of the multi-part object can include eliminating gaps in the multi-part object and at least one of re-ordering or re-labeling of one or more parts of the multi-part object.

Further, an associated data protection application (as discussed later) can track the multi-part object based on the one or more of the deleting, replacing, inserting, or contracting operations.

In step 202, a change made in step 201 as a result of the modifying can be reported to the multi-part object based on receiving a status request for the multi-part object. The response to the status request may include at least one of part numbers, eTags of associated individual parts and concatenated eTags of all parts associated with the multi-part object.

The embodiments of the invention of method 200 include additional tracking and management features for a data protection application applied to the “containerization” of de-duplicated data. At present, some products including de-duplicated extent level database tracking have the following fields for each extent (row): “CHUNKID, POOLID, DIGEST_VALUE, SIZE, CNTRID, OFFSET, LENGTH, REFCOUNT, FLAGS, LAST_REF, INSDATE”.

The embodiments can include augmenting the rows to include a CNTR PARTID field such that the following new tracking table will be added to the data protection (server) application for tracking cloud container object “parts”, where key columns are signified by (*):
Table: CLOUD_CNTR_PARTS
Fields: CNTRID*, PARTID*, EXTENT COUNT

The following algorithm represents the “data ingest algorithm” where a client data stream coming in over a communication session to the data protection application is processed.

First, in the data ingest algorithm, the data protection client application may open a communication channel with the data protection server endpoint. This can be over a TCP/IP (socket), shared memory, or via other communication mechanisms and/or protocols.

Second, in the data ingest algorithm, the client and server applications may authenticate with one another to establish trust and optionally encrypt the communication channel.

Third, in the data ingest algorithm, the client application may begin a “backup” operation by sending a raw data stream to the server over the communication channel.

Fourth, in the data ingest algorithm, the server application may run a de-duplication fingerprinting algorithm on the data stream to identify data extents incrementally across the stream.

Fifth, in the data ingest algorithm, the server may query its database catalog and determine which of these extents are unique and which already exist as “valid” extents referenced by other protected data.

Sixth, in the data ingest algorithm, the server may optionally compress and encrypt the new data extents and store these into new container files on disk storage.

Seventh, in the data ingest algorithm, for each new container file generated and filled with data, CLOUD_CNTR_PARTS records may be inserted for each eventual PARTID that will be stored. The EXTENT_COUNT may be set to however many de-duplicated extents are stored within each part.

Eighth, in the data ingest algorithm, the server inserts database rows for new data extents each with a REFCOUNT of “1” and sets the CHUNKID, POOLID, DIGEST_VALUE, SIZE, CNTRID, OFFSET, LENGTH, FLAGS, LAST_REF, and INSDATE appropriately. The CNTR_PARTID may be set depending on the logical “part” the extent will reside within in the container file/object.

Ninth, in the data ingest algorithm, the server may increment the REFCOUNT of existing data extents.

Tenth, in the data ingest algorithm, using an asynchronous process, container files may be transferred to object storage as “container objects” with a specific part size and quantity of parts.

The following algorithm represents the “data expiration algorithm” where client data is expired either due to age, policy, or manual deletion.

First, in the data expiration algorithm, for each client, the data protection server application may determine data objects/files that are no longer needed. This can be due to exceeding the needed “versions” of an object/file being protected, manual deletion of object/files or client file spaces from storage, or through exceeding a specific age for the object/file.

Second, in the data expiration algorithm, the server application may process objects/files in “batches” (sets) where each “batch” is processed incrementally.

Third, in the data expiration algorithm, for each “batch” of objects/files, the server application may determine the de-duplicated extents making up each client object/file.

Fourth, in the data expiration algorithm, for each of these extents, the server application may decrement the extent-level REFCOUNT.

Fifth, in the data expiration algorithm, if a REFCOUNT for an extent reaches 0, the server application may remove the row for that extent (after a certain additional “buffer” time frame).

Sixth, in the data expiration algorithm, if a REFCOUNT for an extent reaches 0, the server application may also decrement the EXTENT_COUNT of the associated (CNTRID, PARTID) in the CLOUD_CNTR_PARTS table.

Seventh, in the data expiration algorithm, if the EXTENT_COUNT for a (CNTRID, PARTID) reaches 0, the server application makes an API call to the object storage application to erase this part. This (CNTRID, PARTID) row entry may also be removed from the database.

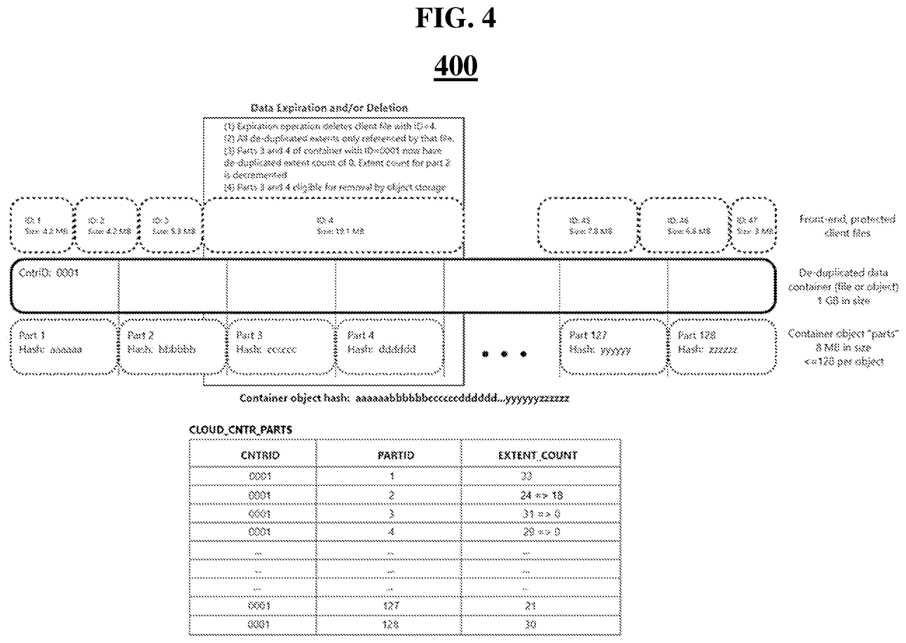

FIG. 4 exemplarily demonstrates the effects of a data expiration and/or a deletion operation involving a single front-end client application file. In example 400, the file with ID=4 may be expired/deleted from the data protection application. For the sake of example 400, this object may be composed of de-duplicated extents that were wholly unique to this file and were not referenced by any other protected file in the system (i.e., the file reference count of all extents was 1 for each extent making up this file). A further assumption is made in this example that the data container object is relatively recent in age. In practice, over time as data expires there might not be a clean mapping between the latest version of front-end client files and the layout of data extents in any one data container (i.e., new versions backed up of the same file with an incremental backup may store new extents into new, different containers). Also, for the sake of example 400, it is assumed that this is the only version of these files being protected (although this algorithm will apply in other cases as well).

Still with reference to example 400 in FIG. 4, here the file with ID=4 may be eliminated from the system and all of the de-duplicated extents making up this file are no longer needed. The data protection application may use the information it its extent-level tracking table to determine the container parts that need decrementing. The data protection application may decrement the extent count for container part number 2 for container with ID-0001 and may set to “0” the extent count for parts 3 and 4, and then make an API call to the object storage device to erase parts 3 and 4 of this object. As a part of this API call (or a subsequent, separate API call, depending on the implementation provided by the object storage system), the data protection application may update its tracking of the container object's end-to-end hash with the new value.

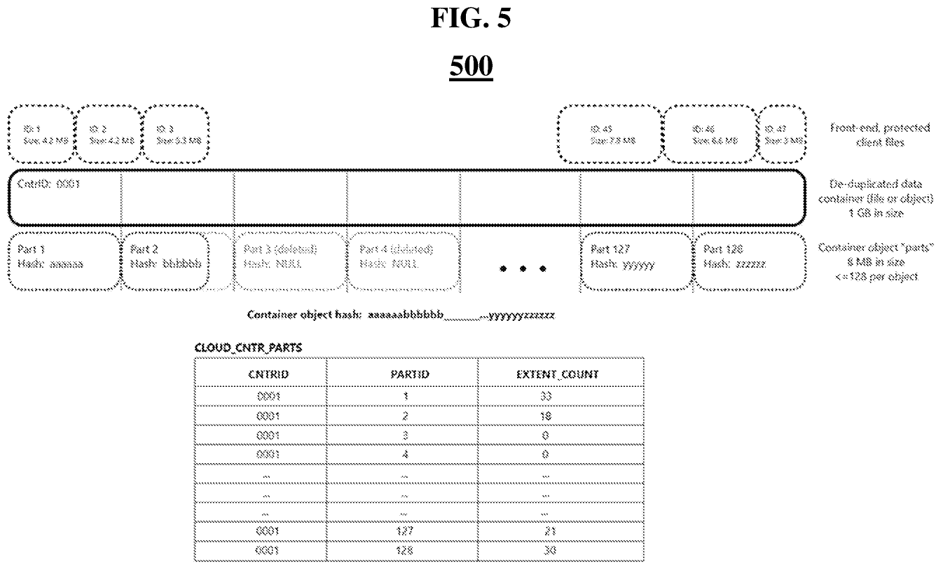

With reference to FIG. 5, afterwards, the new container object hash 500 may include “NULL” values (all 0s for example) for the deleted parts. These parts within the container object may no longer be used by the data protection application, but records will still persist in the CLOUD_CNTR_PARTS tracking table (with an EXTENT_COUNT of 0). When all parts for a container object are no longer needed, the data protection application may perform the proper API call to erase the container object from the object storage system.

Thereby, one exemplary advantage of this invention for a data protection application is that it may help the application owner avoid the additional metered HTTP operational cost and egress/ingress costs of traditional “cloud reclamation”. Public cloud service providers typically charge metered rates depending on the type and quantity of HTTP requests issued against object storage (e.g., PUT, GET, DELETE, etc.). Particularly, for GET operations to fetch needed data, this can be prohibitive. The incurred “cost” not only involves fetching potentially thousands of de-duplicated extents from these objects in terms of data egress and GETs, but also the CPU, Ethernet networking, and data protect application “maintenance cycle” time associated with the operation where the opportunity cost of other productive work for the application must be factored in.

Based on the above disclosure, the invention provides a technique for the data protection application to save storage space in object storage using light-weight API calls and internal database updates with minimal data movement and time involved.

An alternative embodiment of this invention may allow for the data protection application to “re-use” these parts if the object storage application allows for this.

In the alternative embodiment, during new client application backup, the application may store new de-duplicated extents into existing EXTENT_COUNT=0 parts of existing containers. The extent-level tracking table may include PARTID information reflective of this extent-level location and the CLOUD_CNTR_PARTS table may be updated to reflect the new EXTENT_COUNT.

The data protection application may “buffer” these extents together until enough are collected to fill a container object part size and then this data would be stored using the appropriate object storage system API call. This approach has the advantage of avoiding the overhead of “staging” data during backup to a container file that is then later uploaded to object storage using multi-part upload (e.g., a common practice with an application such as Spectrum Protect and its cloud-container storage pools).

One advantage of this idea in its entirety is that it may eliminate the need to perform the traditional “cloud reclamation” maintenance task. This maintenance task involves determining which cloud containers (objects) meet a certain threshold percentage of “unused” space, then processing these objects to obtain the still-referenced extents and store these out as new container objects.

Thus, as a result of the embodiments of the invention, the invention can avoid additional maintenance task time, avoid CPU processing, RAM, and Ethernet usage associated with the task, avoid metered operational and egress/ingress charges for harvesting and storing data, and avoid additional database work related to tracking new container objects.

### Exemplary Aspects, Using a Computing Environment

With reference now to FIG. 1, computing environment 100 contains an example of an environment for the execution of at least some of the computer code involved in performing the inventive methods, such as stored multi-part object management code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented method for managing a stored multi-part object in a data storage application, the computer-implemented method comprising:
modifying a stored multi-part object based on executing a predetermined operation; and
reporting a change to the multi-part object as a result of the modifying based on receiving a status request for the multi-part object.

2. The computer-implemented method of claim 1, wherein the predetermined operation includes a plurality of operations, and
wherein the modifying is based on executing at least one of the plurality of operations comprising:
deleting one or more parts from the multi-part object;
replacing one or more parts of the multi-part object;
inserting one or more parts into the multi-part object; and
contracting the multi-part object.

3. The computer-implemented method of claim 2, wherein the inserting includes at least one of re-ordering or re-labeling of the one or more parts of the multi-part object.

4. The computer-implemented method of claim 2, wherein the contracting eliminates gaps in the multi-part object and at least one of re-ordering or re-labeling of the one or more parts of the multi-part object.

5. The computer-implemented method of claim 1, wherein the response to the status request includes at least one of part numbers, eTags of associated individual parts and concatenated eTags of all parts associated with the multi-part object.

6. The computer-implemented method of claim 2, wherein an associated data protection application tracks the multi-part object based on the at least one of the deleting, replacing, inserting and contracting operations.

7. The computer-implemented stored multi-part object management method of claim 1, embodied in a cloud-computing environment.

8. A stored multi-part object management computer program product for managing a stored multi-part object in a data storage application, the stored multi-part object management computer program product comprising a computer-readable storage medium having program instructions embodied therewith, the program instructions executable by a computer to cause the computer to perform:
modifying a stored multi-part object based on executing a predetermined operation; and
reporting a change to the multi-part object as a result of the modifying based on receiving a status request for the multi-part object.

9. The stored multi-part object management computer program product of claim 8, wherein the predetermined operation includes a plurality of operations, and
wherein the modifying is based on executing at least one of the plurality of operations comprising:
deleting one or more parts from the multi-part object;
replacing one or more parts of the multi-part object;
inserting one or more parts into the multi-part object; and
contracting the multi-part object.

10. The stored multi-part object management computer program product of claim 9, wherein the inserting includes at least one of re-ordering or re-labeling of the one or more parts of the multi-part object.

11. The stored multi-part object management computer program product of claim 9, wherein the contracting eliminates gaps in the multi-part object and at least one of re-ordering or re-labeling of the one or more parts of the multi-part object.

12. The stored multi-part object management computer program product of claim 8, wherein the response to the status request comprises at least one of part numbers, eTags of associated individual parts and concatenated eTags of all parts associated with the multi-part object.

13. The stored multi-part object management computer program product of claim 9, wherein an associated data protection application tracks the multi-part object based on the at least one of the deleting, replacing, inserting and contracting operations.

14. A stored multi-part object management system for managing a stored multi-part object in a data storage application, the stored multi-part object management system comprising:
a processor; and
a memory, the memory storing instructions to cause the processor to perform:
modifying a stored multi-part object based on executing a predetermined operation; and
reporting a change to the multi-part object as a result of the modifying based on receiving a status request for the multi-part object.

15. The stored multi-part object management system of claim 14, wherein the predetermined operation includes a plurality of operations, and
wherein the modifying is based on executing at least one of the plurality of operations comprising:
deleting one or more parts from the multi-part object;
replacing one or more parts of the multi-part object;
inserting one or more parts into the multi-part object; and
contracting the multi-part object.

16. The stored multi-part object management system of claim 15, wherein the inserting comprises at least one of re-ordering or re-labeling of the one or more parts of the multi-part object.

17. The stored multi-part object management system of claim 15, wherein the contracting eliminates gaps in the multi-part object and at least one of re-ordering or re-labeling of the one or more parts of the multi-part object.

18. The stored multi-part object management system of claim 14, wherein the response to the status request includes at least one of part numbers, eTags of associated individual parts and concatenated eTags of all parts associated with the multi-part object.

19. The stored multi-part object management system of claim 15, wherein an associated data protection application tracks the multi-part object based on the at least one of the deleting, replacing, inserting and contracting operations.

20. The stored multi-part object management system of claim 16, embodied in a cloud-computing environment.
